(19) United States
(12) Patent Application Publication
(10) Pub. No.: US 2007/0263248 A1
(43) Pub. Date: Nov. 15, 2007

(54) Network plug-and-play compliant network relay device

(75) Inventors: Yasuhiro Oshima, Nagano-ken (JP); Yoji Takada, Nagano-ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/652,246

(22) Filed: Jan. 10, 2007

(30) Foreign Application Priority Data
Jan. 12, 2006 (JP) 2006-5229

(51) Int. Cl. G06F 3/12

(52) U.S. Cl. 358/1.15

(57) ABSTRACT

A network relay device, which is compliant with network plug-and-play, is used for relaying between a network and a device unit having one or more service devices that provide a service in response to a request from a client on the network. The network relay device includes a data conversion module that, upon receiving from a client a print request message describing in markup language an image for printing, converts the print request message to data for use by the device unit and supplies the converted data to the device unit. The data conversion module creates, as the data for use by the device unit, printer data according to a universal standard acceptable by the device unit.

### CROSS-REFERENCE TO RELATED APPLICATIONS

The present application claims the priority based on Japanese Patent Application No. 2005-5229 filed on Jan. 12, 2005, the disclosure of which is hereby incorporated by reference in its entirety.

### BACKGROUND OF THE INVENTION

1. Field of the Invention

The present invention relates to control technology for a network plug-and-play compliant network relay device.

2. Description of the Related Art

Plug-and-play is a well-known technology that enables peripheral devices to be connected to a computer or disconnected from a computer at arbitrary timing after startup of the computer. In recent years, extension of plug-and-play technology to networks has led the development of Universal Plug and Play (hereinafter UPnP; UPnP is a trademark of UPnP Implementers Corporation). The use of UPnP enables network devices to be connected to a network or disconnected from the network at arbitrary timing. Herein, the architecture for realizing such plug-and-play capability in a network shall be termed “network plug-and-play.”

UPnP compliant network devices are able to function as service devices of various kinds. Here, a “service device” refers to a device for providing a service in response to an external request. Service devices can be realized as devices of various kinds (termed “device units”), such as a printer, scanner, fax, copier, memory device, camera, clock or the like. It is also possible for the functions of several service devices to be realized in a single device unit.

It would be desirable if, through the use of a UPnP protocol compliant network relay device, a non-UPnP compliant device unit may be utilized as a UPnP protocol compliant device as well. However, to date, there has not been sufficient research as to how such a relay device would be achieved. In particular, while it is possible for device units having a wide range of functions to be connected to a relay device, there has yet to be devised a satisfactory design for how to operate a device unit when a print request message is received from a client.

### SUMMARY OF THE INVENTION

An object of the present invention is to provide technology for use in a network plug-and-play compliant network, whereby print request messages provided from clients may be relayed to an appropriate device unit.

According to one aspect of the present invention, there is provided a network relay device compliant with network plug-and-play, for relay between a network and a device unit having one or more service devices that provide a service in response to a request from a client on the network. The network relay device includes a data conversion module that, upon receiving from a client a print request message describing in markup language an image for printing, converts the print request message to data for use by the device unit and supplies the converted data to the device unit. The data conversion module creates, as the data for use by the device unit, printer data according to a universal standard acceptable by the device unit.

With this relay device, a print request message is converted to printer data according to a universal standard acceptable by the device unit that is actually connected to the relay device, and the converted data is supplied to the device unit, whereby it is possible for the print request message to be relayed appropriately to the device unit. Since the printer data is in accordance with a universal standard, there is no need for the relay device to be configured to create data in a format unique to individual printers, thus facilitating implementation of the relay device.

It is possible for the present invention to be reduced to practice in various forms, for example, a network device; a network protocol control device; a control method and a control device for such devices; a computer program for realizing the functions of such a method or device; a recording medium having such a computer program recorded thereon; a data signal containing such a computer program and embodied in a carrier wave; and so on.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a conceptual diagram depicting the configuration of a network system implementing the embodiment of the invention;

FIG. 2 is a block diagram depicting the internal arrangement of the MFP server and the MFP device control unit within the relay unit;

FIG. 3 is a sequence diagram depicting a typical example of processing using UPnP architecture;

FIGS. 4A and 4B illustrate the arrangement of the two data conversion modules installed within the device controller; and

FIG. 5 is a sequence diagram illustrating the sequence for connecting a printer to the relay unit and executing printing.

### DESCRIPTION OF THE PREFERRED EMBODIMENT

The embodiments of the invention will be described in the order indicated below.

A. Description of Terms

B. System Overview

C. Arrangement of Print Data Conversion Module and Process Sequence

D. Variation Examples

A. Description of Terms

The meanings of certain terms used in the following description are as follows.

DHCP (Dynamic Host Configuration Protocol): a protocol for dynamically assigning IP addresses.

GENA (General Event Notification Architecture): In UPnP architecture, used when an event is issued.

HTTP (HyperText Transfer Protocol): the hypertext transfer protocol.

HTTPMU (HTTP Multicast over UDP): HTTP multicasting using UDP (User Datagram Protocol).

HTTPU (HTTP (unicast) over UDP): HTTP unicasting using UDP.

MFP (Multi Function Peripheral): A multi function peripheral device having the functions of several devices.

SOAP (Simple Object Access Protocol): In UPnP architecture, used for action request and response by RPC (Remote Procedure Call).

SSDP (Simple Service Discovery Protocol): In UPnP architecture, used for service discovery (detection).

UPnP (Universal Plug and Play): trademark of UPnP Implementers Corporation.

URI (Uniform Resource Identifier): a broader concept of URL (Uniform Resource Locator); an identifier indicating the unique location of a resource.

XHTML (extensible HyperText Markup Language): A type of text markup language compatible with HTML, representing one implementation of XML. XHTML-print, discussed later, is a standard for printing XHTML documents.

XML (extensible Markup Language): extensible Markup Language

The numerous protocols mentioned above are used in UPnP, and will herein be referred to collectively as “UPnP protocols.”

B. System Overview

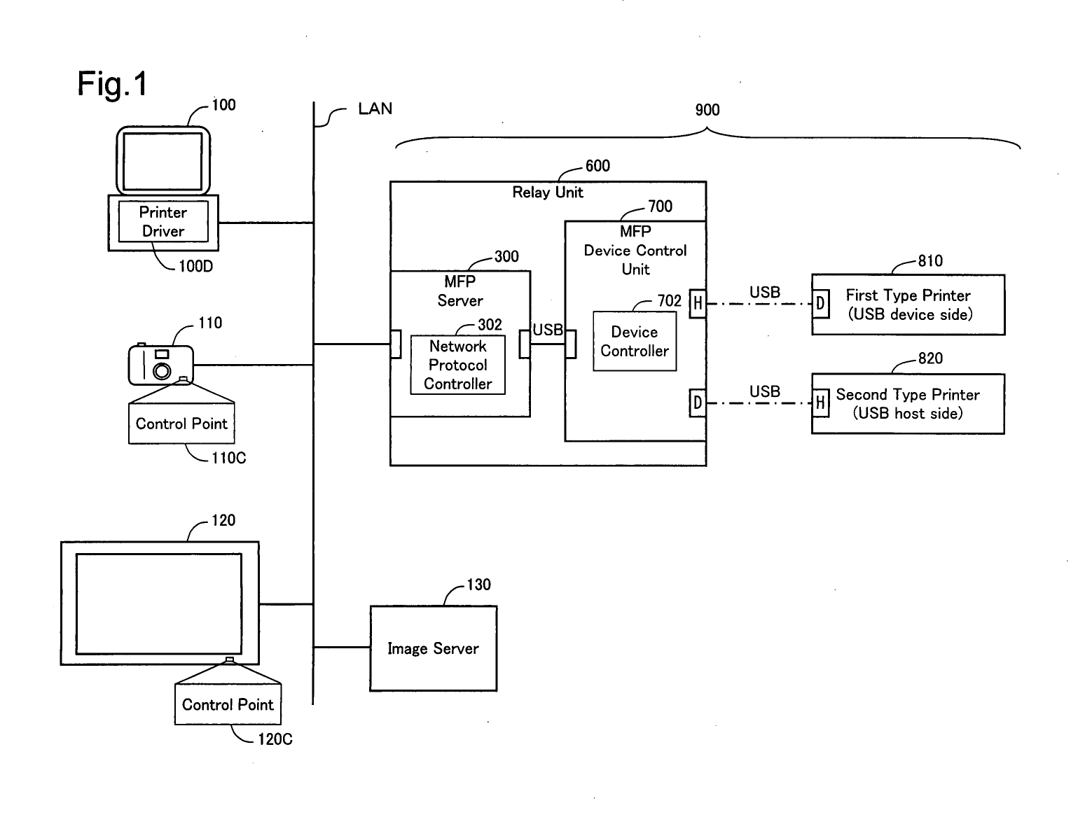

FIG. 1 is a conceptual diagram depicting the configuration of a network system implementing an embodiment of the invention. This network system comprises a personal computer 100, a digital camera 110, a digital TV set 120, an image server 130, and a relay unit 600, interconnected via a LAN. The relay unit 600 is selectively connectable to a first printer 810 (first type printer) and a second printer 820 (second type printer). The first printer 810 is a printer that functions as a USB device, while the second printer 820 is a printer that functions as a USB host. The letter “H” inside the rectangle denoting the USB terminal denotes the host terminal, while “D” denotes the device terminal. While the printers 810, 820 per se are noncompliant with UPnP protocols, the relay unit 600 executes processes in accordance with UPnP protocols. Accordingly, the device 900 composed of the relay unit 600 and the printer 810 and/or 820 can function as a UPnP-compliant network device. The LAN may be a wired network such as IEEE 802.3, or a wireless network such as IEEE 802.11 b/g/a. The digital camera 110 and the digital TV set 120 are UPnP-compliant network devices. The digital camera 110 and the digital TV set 120 comprise control points 110C, 120C in UPnP architecture. UPnP architecture and control points will be discussed later. While the personal computer 100 and the image server 130 are also one element in this network system, they are not UPnP compliant.

The personal computer 100 has the function of creating print data for images using a printer driver 100D, and of transferring via the LAN this print data via the relay unit 600 to the printer 810 or 820 for printing. During this printing process, the printer 810 or 820 functions as an ordinary network printer. On the other hand, in the event that printing is carried out in accordance with a request from a control point (e.g. 110C), the network device 900 composed of the printer 810 or 820 and the relay unit 600 will function as a UPnP compliant printer device.

The relay unit 600 has an MFP server 300 and a MFP device control unit 700. The MFP server 300 functions as a network protocol controller 302 for mediating messages exchanged between the MFP device control unit 700 and other devices on the LAN. As will be discussed later, in typical cases, during message transfer the MFP server 300 interprets the UPnP protocols in relation to the message header, but neither interprets nor processes the message body.

The MFP device control unit 700 functions as a device controller 702 for controlling the printer 810 or 820 in response to a request from a client.

The MFP server 300 and the MFP device control unit 700 are connected by a USB (Universal Serial Bus); the MFP device control unit 700 and the printers 810 and 820 are also connected by USB. However, it is possible to utilize some other physical interface besides USB. It is also possible for the MFP server 300 and the MFP device control unit 700 to be connected with a communications protocol different from the UPnP protocols.

It is also possible for the printer 810 or 820 to constitute a multifunction device that provides services besides printing. Typically, a unit connected to the relay unit 600 is termed a “device unit.” A device unit has at least one service device; typically, it will be designed to have N service devices where N is an integer of 1 or greater.

When the control point 110C or 120C sends the network device 900 a print request message (e.g. XHTML-print data) in accordance with the UPnP protocols, the MFP device control unit 700 interprets this print request message, converts it to printer data in accordance with the universal standard appropriate for the printer which is actually connected, and sends the converted data to the printer 810 or 820. The printer data will preferably contain data for use in image display, such as RGB data or JPEG data. The printer 810 or 820 executes color conversion and halftone processing on the received printer data and creates print data; printing will be executed according to this print data. “Print data” refers to data representing the dot formation state for ink dots of each ink used by the printer, and is clearly distinguished from data used for image display purposes (e.g. RGB data or JPEG data). A message of a format other than XHTML-print data may be used as the print request message. In general, it is possible to use a print request message in which an image for printing is described in markup language.

UPnP is an architecture whereby it is possible to connect a network device to a network or disconnect it from the network, at arbitrary timing. The UPnP network is composed of the control points 110C, 120C and the service devices 810 or 820. Here, “service device” refers to a device which provides a service. Unless indicated otherwise herein, “device” and “service device” are used synonymously. A “control point” means a controller that detects and controls another device or devices on the network, and that functions as a client for service devices. The various functions of UPnP-compliant network devices will be discussed later.

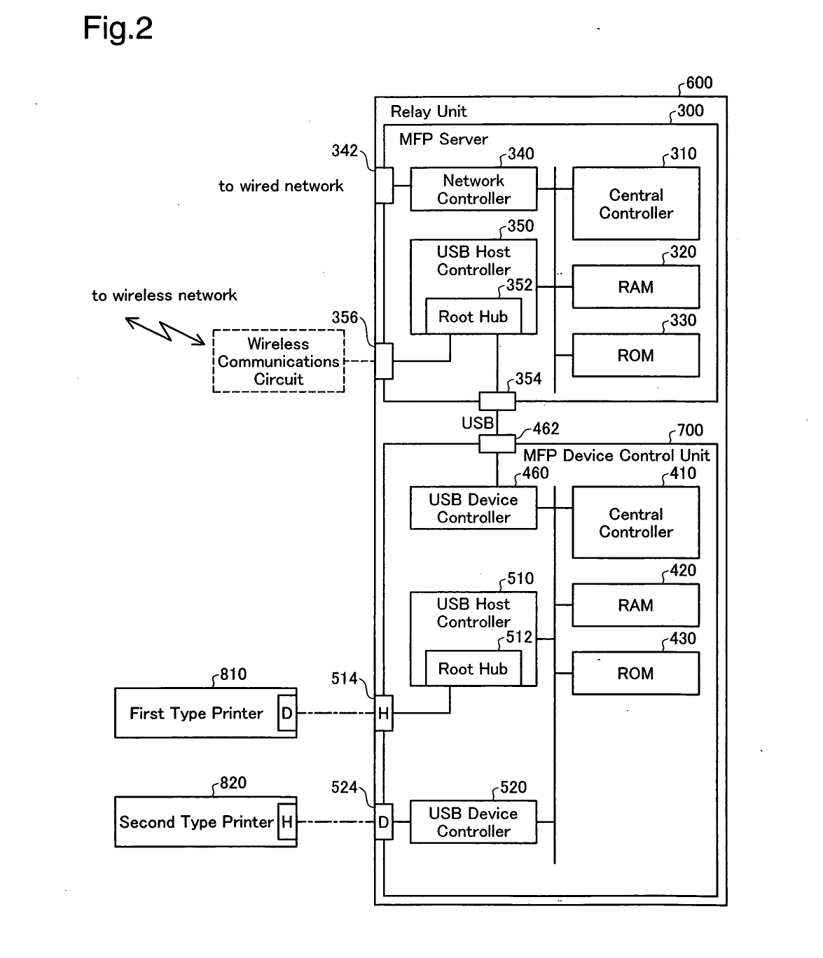

FIG. 2 is a block diagram depicting the internal arrangement of the MFP server 300 and the MFP device control unit 700 within the relay unit 600. The MFP server 300 has a central controller (CPU) 310, RAM 320, ROM 330, a network controller 340, and a USB host controller 350. The network controller 340 is connected to a wired network via a connector 342. The USB host controller 350 has a root hub 352, with two USB connectors 354, 356 provided to the root hub 352. The first USB connector 354 connects via a USB cable to the USB connector 462 of the MFP device control unit 700. An additional device (e.g. a wireless communication circuit for communicating with a wireless LAN network) can be connected to the second USB connector 356.

The MFP device control unit 700 has a central controller (CPU) 410, RAM 420, ROM 430, a first USB device controller 460, a USB host controller 510, and a second USB device controller 520. The first USB device controller 460 is connected via the USB connector 462 to the USB host controller 350 of the MFP server 300. The USB host controller 510 has a root hub 512, with a USB connector 514 (USB host terminal) provided to the root hub 512. The printer 810 of the first type is connectable to this connector 514. The second USB device controller 520 has a connector 524 (USB device terminal); the printer 830 of the second type is connectable to this connector 524. In preferred practice the relay unit 600 will have a mechanism (e.g. a moveable terminal cover) enabling selective connection to either the printer 810 of the first type or the printer 820 of the second type, but not both at any given time. In preferred practice the relay unit 600 and the device unit 810 or 820 will be connected through multiple logical channels for multiple applications. Use of multiple logical channels are well known in the art, and detailed description of the logical channels will be omitted in this specification.

The central controller 310, the network controller 340, and the USB host controller 350 of the MFP server 300 performs the functions of the network protocol controller 302 shown in FIG. 1. More specifically, the network controller 340 carries out sending and receiving of messages according to the various network protocols. The central controller 310 interprets the UPnP protocols and determines the transfer destination. The USB host controller 350 transfers messages to and from the MFP device control unit 700. These controllers 310, 340, 350 transfer messages without interpreting (parsing) or processing the message body.

The USB device controller 460 of the MFP device control unit 700 carries out sending and receiving of messages according to USB transfer protocol. The central controller 410 performs the functions of the device controller 702 (FIG. 1), which interprets the content of messages transferred via the MFP server 300, executes processing in response to message content to create control data, and sends the control data to the device unit 810 or 820. Operation of the service device 810 or 820 is controlled in accordance with this control data. Rather than a separate arrangement of MFP server 300 and MFP device control unit 700, the functions of both the MFP server 300 and the MFP device control unit 700 may be integrated into a single unit.

UPnP architecture is composed according to various protocols such as HTTPMU, HTTPU, SOAP/HTTP, and HTTP. UPnP uses these protocols in accomplishing various processes such as the following.
(1) Addressing

When a UPnP device (hereinafter referred to simply as a “device”) is connected to the network, a network address (IP address) is obtained by means of addressing. A DHCP server or Auto-IP is used for addressing. Where the network is equipped with a DHCP server, the device uses an IP address assigned by the DHCP server. Where there is no DHCP server, the device itself decides on an address, using an automatic IP addressing function called Auto-IP. In this embodiment, only a single IP address is assigned to the network device 900 including the relay unit 600 and the device unit 810 and/or 820, and the entire device 900 is recognized as being a single network device.
(2) Discovery (Detection)

Discovery is a process whereby a control point discovers where devices are located. Discovery can be accomplished by means of multicasting a discovery message by the control point, or by means of advertising the control point from a device that a device has joined the network. Discovery is carried out using HTTPMU/SSDP or HTTPU/SSDP. As a result of discovery, the control point and the device can proceed with processing on a peer-to-peer basis.
(3) Description

The specifics of the configuration of a device are described in XML by way of a device description. The specifics of the services provided by a device are described in XML by way of a service description. These descriptions are possessed by individual devices and are provided to a control point. The control point, by means of referring to these descriptions, can ascertain the specifics of a device and its services.
(4) Control

Control is a process whereby a control point transfers to a device a control message that includes an action request, and performs control of the device. Control is carried out using HTTP/SOAP.
(5) Eventing

When a prescribed event occurs, a service in the device notifies the control point that an event has occurred. Upon receiving notification that the event has occurred, the control point “subscribes” to that service. The event is transferred to the subscribing control point. Event notification is carried out using HTTP/GENA.
(6) Presentation

Presentation is a process wherein a control point acquires a presentation page described in HTML, from a presentation URL registered in the device description. By means of presentation, the control point can display the state of various devices, for example.

The present invention is applicable to future versions of UPnP as well. The present invention is also applicable to network plug-and-play standards other than UPnP, provided that the network plug-and-play standard enables peer-to-peer communication between any control point and device by means of addressing (automatic IP address determination) and device discovery, and that the architecture is one in which control points and devices exchange messages.

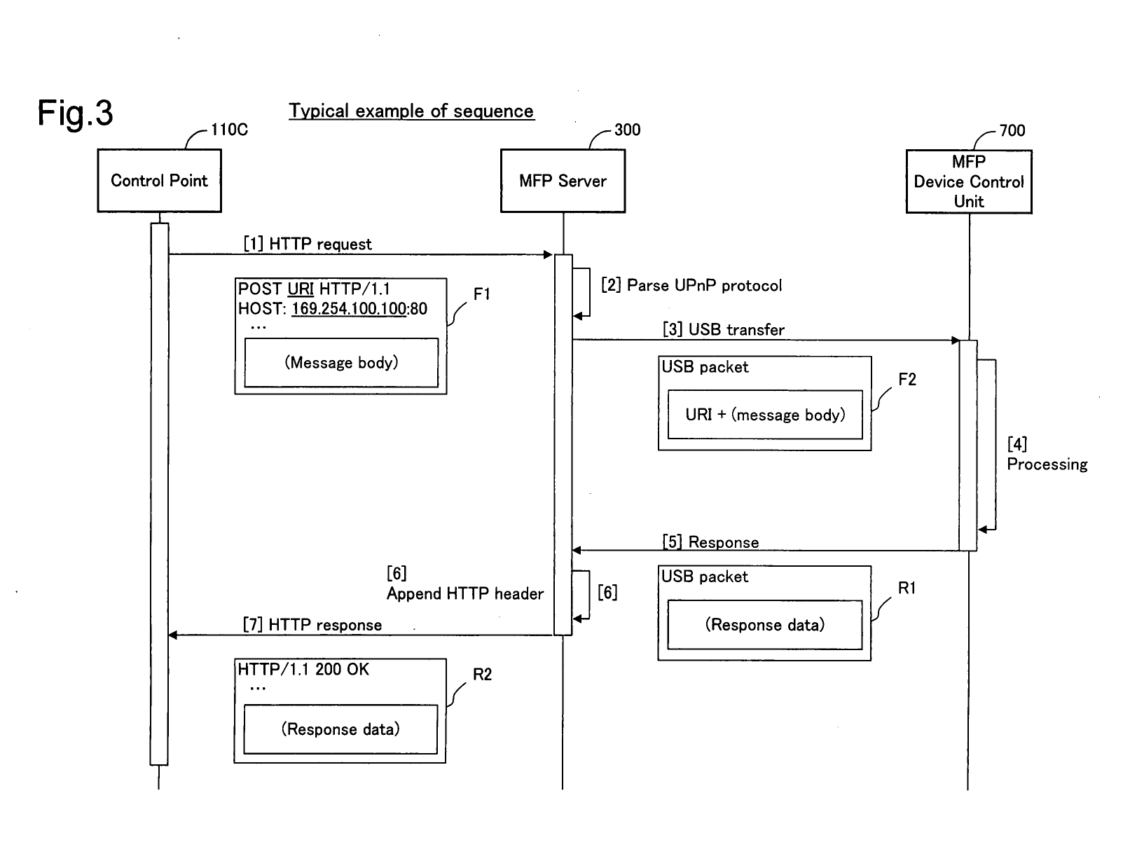

FIG. 3 is a sequence diagram depicting a typical example of a process utilizing UPnP architecture. Here, there is depicted an instance of message transfer among a control point 110C, the MFP server 300, and the MFP device control unit 700. Actually various control data and status information are exchanged between the MFP device control unit 700 and the device unit 810 or 820, but they are not shown here for the simplicity of illustration. In Step 1, the control point 110C transfers an HTTP request message F1 to the MFP server 300. It should be noted that the step numbers are enclosed by brackets in the sequence diagrams. The header of the message F1 describes a request command method (e.g. POST or GET), the URI of an address within the network device 900 (FIG. 1), and the host name of the network device 900 (in this example, the IP address “169.254.100.100”). Since the network device 900 is assigned a single IP address, it is possible to think of this IP address as either the IP address of the MFP server 300, or the IP address of the MFP device control unit 700, or the IP address of the device unit 810 or 820.

In Step 2, the MFP server 300 parses the request message F1. Here, only the header portion of the message F1 is parsed or interpreted; the content of the transmission data (i.e. the message body) is not interpreted. More specifically, in Step 2, the URI of the message F1 is parsed to determine which logical channel should be used for transferring the massage to the MFP device control unit 700. In certain instances, however, the request message F1 may lack a substantial message body.

In Step 3, the MFP server 300 transfers the message F2 containing the URI and the message body (where present) to the MFP device control unit 700 by USB. During this transfer, a logical channel selected with reference to the URI is used.

In Step 4, the MFP device control unit 700 executes processing with reference to the URI and the message body (where present) in the received message F2. For example, the MPF device control unit 700 parses or interprets the content of the message body to produce control data for the device unit 810 or 820, and transfers the control data to the device unit 810 or 820. In Step 5, the MFP device control unit 700 transfers by USB to the MFP server 300 a message R1 which includes response data. In Step 6, the MFP server 300 appends an HTTP header to the transmission data. This HTTP header includes a status code indicating the result of processing the HTTP request. For example, where the process result is OK, the status code is set to “200” whereas if there is an error it is set to “500.” In Step 7, an HTTP response message R2 created in this way is transferred from the MFP server 300 to the control point 110C.

In this way, in this embodiment, from a request message received from a control point, the MFP server 300 performs parsing (interpretation) of the header of the message, without interpreting the content of the message body, and the message body is processed by the MFP device control unit 700. This arrangement has advantages such as the following. A first advantage is that the MFP server 300 does not need to ascertain the device configuration and service content of the device unit, allowing it to function as a network protocol controller for transferring messages destined for a device unit of any configuration. A second advantage is that even if the device configuration or service content of the device unit should change, there is no need to modify the configuration or functions of the MFP server 300. A third advantage is that since there is no need for the MFP server 300 to mount an interpreter or parser for interpreting the content of the message body, a simpler configuration for the MFP server 300 will suffice.

C. Arrangement of Print Data Conversion Module and Process Sequence

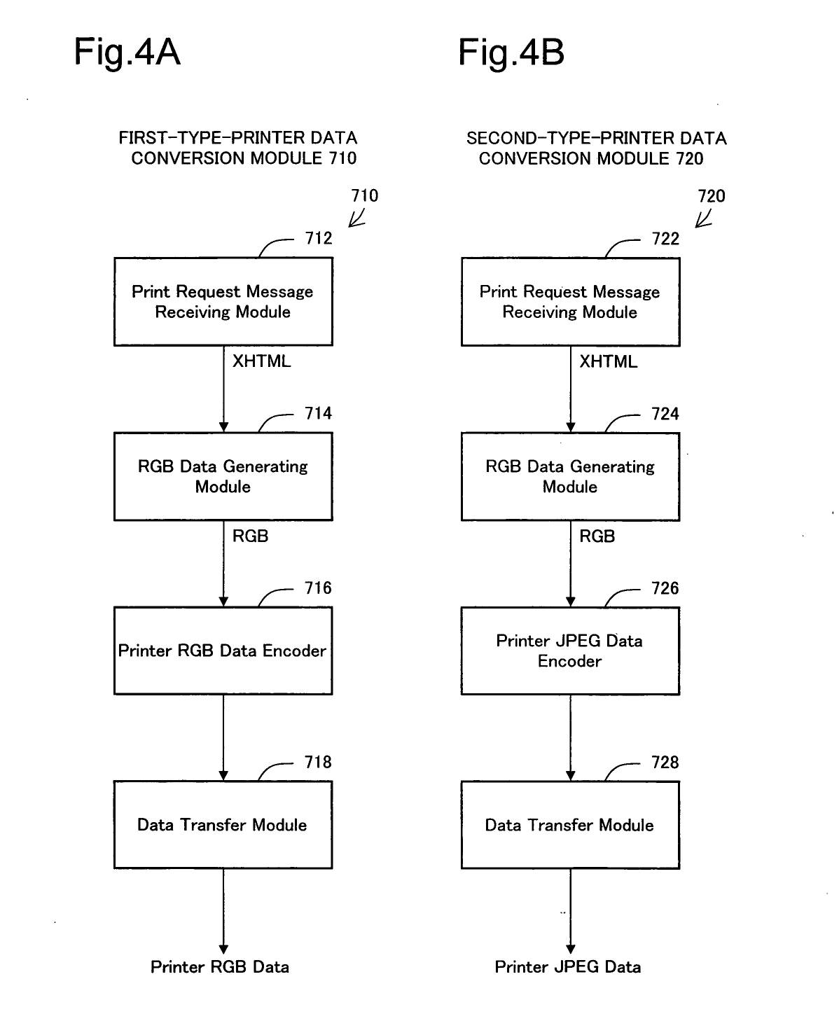

FIGS. 4A and 4B show the arrangement of the two data conversion modules 710, 720 installed within the device controller 702. The first data conversion module 710 shown in FIG. 4A is for use by the printer 810 of the first type; the second data conversion module 720 shown in FIG. 4B is for use by the printer 820 of the second type. The functions of the two modules may instead be integrated in a single module.

The first data conversion module 710 has a print request message receiving module 712, an RGB data generating module 714, a printer RGB data encoder 716, and a data transfer module 718. The print request message receiving module 712 receives XHTML-print data supplied to it by a client (i.e. a control point). The RGB data generating module 714 parses this XHTML-print data, performs layout of the image for printing, and generates RGB data representing each page of the image for printing. In the event that image data is looked up in the XHTML-print data, the RGB data generating module 714 will also execute a process for acquiring the image data from the lookup location. The encoder 716 converts this RGB data to printer suitable RGB data of a format appropriate for the first type printer 810. The first type printer 810A may be a printer which is compliant with the ESC/P-R format, which is a universal standard for printer control. That is, a printer which is compliant with the ESC/P-R format is capable of receiving printer data (ESC/P-R data) that includes RGB data, and executing printing in accordance therewith.

The second data conversion module 720 has a print request message receiving module 722, an RGB data generating module 724, a printer JPEG data encoder 726, and a data transfer module 728. The print request message receiving module 722 and the RGB data generating module 724 may be identical to those in the first data conversion module 710. The encoder 726 converts RGB data to printer suitable JPEG data of a format appropriate for the second type printer 820. The second type printer 820 may be a printer which is compliant with the PictBridge format (PictBridge is a trademark of the Camera & Imaging Products Association (CIPA)), which is a universal standard. That is, a printer which is compliant with the PictBridge format is capable of receiving printer data that includes JPEG data, and executing printing in accordance therewith.

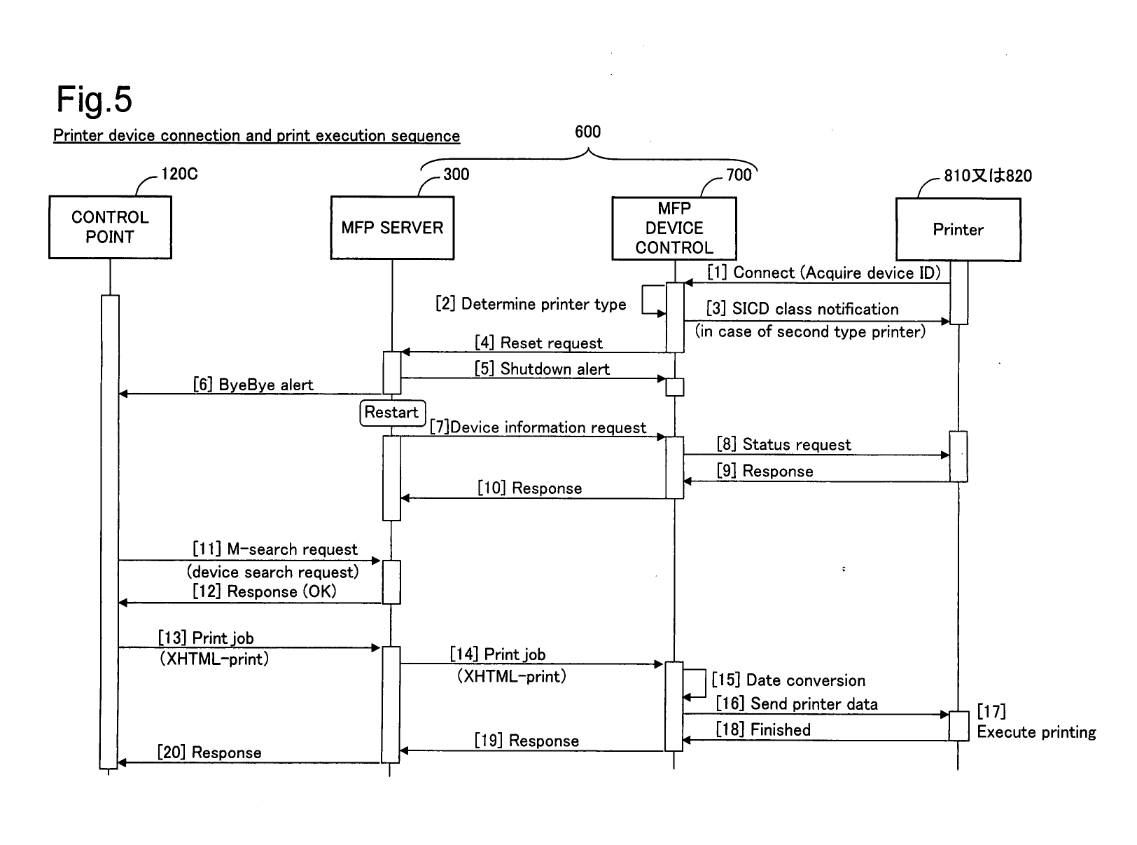

FIG. 5 is a sequence diagram illustrating the sequence for connecting a printer to the relay unit 600 and executing printing.

In Step 1, the MFP device control unit 700 detects if connection is established between the relay unit 600 and the printer 810 or 820. Here, “connection establishment” refers not only to initiation of a physical connection of a cable and connector, but in the wider sense includes also the case where the two devices 700 and 810 (or 820) have been started up with a physical connection of the cable maintained. In the case of a wireless connection, “connection establishment” refers to the state where acknowledgement of the two devices 700 and 810 (or 820) has been completed, and substantive data transfer is enabled. At the time of connection, a device ID is provided to the MFP device control unit 700 from the printer.

In Step 2, the MFP device control unit 700 decides whether either of the first type printer 810 and the second type printer 820 has been connected. This decision can be made with reference to the type of USB terminal (host terminal or device terminal) which is being used to connect the printer. Where the first type printer 810 has been connected, it is preferable for the device ID supplied in Step 1 to include a text string indicating compatibility with the standard for the first type printer (e.g. the ESC/P-R standard). At this time, it will be possible to ascertain from the device ID that the printer conforms to the standard for the first type printer. Where the second type printer 820 has been connected, in Step 3, the MFP device control unit 700 notifies the printer 820 that the relay unit 600 functions as a USB SICD (Still Image Capture Device) class. In this case, the second type printer 820 will recognize that a digital camera has been connected, and execute a printing process in response. Specifically, when the second type printer 820 receives display image data such as JPEG data, it executes printing in response thereto.

Once the printer has been connected, in Step 4, the MFP device control unit 700 sends a reset request to the MFP server 300. In Step 5, the MFP server 300 sends a shutdown alert to the MFP device control unit 700 as a response to the reset request. In Step 6 the MFP server 300 multicasts a ByeBye alert to the control points. The shutdown alert is an alert to the effect that the MFP server 300 will perform a restart. The ByeBye alert is an alert in UPnP protocols, informing all of the control points that an MFP device will be pulled from the network. The reason that the MFP server 300 multicasts a ByeBye alert and performs a restart is that in the UPnP standard, these operations must be carried out when recreating a device description. The MFP server 300 subsequently restarts. The MFP device control unit 700 may restart together with the MFP server 300. It is also possible to omit Steps 4-6 and the MFP server 300 restart.

In Step 7 in FIG. 5, the MFP server 300 requests the MFP device control unit 700 for device information. This request for device information is a process carried out when the MFP server 300 restarts, and is carried out for the purpose of the MFP server 300 acquiring various device information, including the number of devices belonging to the UPnP complaint network device 900, the number of services, the device type of each device, the service type of each service, and the content of the services that can be provided (i.e. device capabilities). In Step 8, the MFP device control unit 700 transfers this device information request to the printer 810 (or 820). The printer 810 or 820 responds to this request by sending back device information of various kinds including device capability information (Step 9), and the MFP device control unit 700 transfers this device information to the MFP server 300 (Step 10).

In the example of FIG. 5, in the subsequent Step 11, an M-Search request is multicast from the control point 120. In the UPnP protocols, an M-Search request is issued for the purpose of a control point to search for a device. In response to this request, all UPnP-compliant network devices connected to the network return a response to the control point 120C that issued the request (Step 12).

In Step 13, the control point 120C sends a print job message to the network device 900. This print job message is composed of XHTML-print data. The print job message is also called a “print request message.” Once the MFP server 300 transfers this print job message to the MFP device control unit 700 (Step 14), data conversion is carried out within the MFP device control unit 700 (Step 15). Specifically, in the event that the first type printer 810 has been connected to the relay unit 600, the data conversion module 710 suitable for the first type printer (FIG. 4A) parses the XHTML-print data and creates RGB data for the printer. On the other hand, in the event that the second type printer 820 has been connected to the relay unit 600, the data conversion module 720 suitable for the second type printer (FIG. 4B) parses the XHTML-print data and creates JPEG data for the printer. The printer data created in this way is sent to the printer 810 or 820 (Step 16), and printing is executed in accordance with this printer data (Step 17).

Upon completion of printing, notification to that effect is sent from the printer 810 (or 820) to the MFP device control unit 700 (Step 18), and a response is returned via the MFP server to the control point 120C which originated the print request (Steps 19, 20). Alternatively, the response in Steps 18-20 may be returned without waiting for printing to finish.

According to the above embodiment, when the relay unit 600 and a printer are connected, it is determined which of the first type printer 810 and the second type printer 820 has been connected, and printer data according to the universal standard with which the actually connected printer is compliant is created from XHTML data. Consequently, regardless of whether the first type printer 810 or the second type printer 820 has been connected, it is possible for printer data appropriate to each to be supplied to the printer, and for printing to be executed according thereto. Moreover, since the first type printer 810 and the second type printer 820 can each accept printer data in accordance with universal standards, there is no need in the relay unit 600 to perform conversion to printer-specific print data that is dependent on an individual printer model, such as print data having dot data for each ink color. It is accordingly acceptable simply to install the modules 710, 720 shown in FIGS. 4A and 4B that create printer data according a universal standard as the relay unit 600, which has the advantage of easy installation of the relay unit 600.

D. Modified Examples

The invention is not limited to the embodiment discussed above, and may be reduced to practice in various other forms without departing from the spirit thereof, such as following modifications, for example.

D1. Modified Example 1

It is possible to use a device unit containing several devices as the device unit connected to the relay unit 600. It is also possible to use a device unit that includes only one non-printer device (e.g. mass storage). For example, where a device unit having only a mass storage device has been connected to the relay unit 600, the print request message may be converted to printer data according to a pre-selected universal standard (e.g. JPEG data), and sent from the relay unit 600 to the mass storage device for storage. As will be apparent from this description, in preferred practice there may be employed an arrangement whereby when the relay unit 600 receives from a client a print request message describing in markup language an image for printing, printer data according to universal standard acceptable by the actually connected device unit will be created and supplied to the device unit. Herein, “universal standard” refers not to the proprietary standard of a manufacturer, but rather to standards employed in common by multiple manufacturers. Such universal standards are not just official, but include industry standards (de facto standards) as well.

D2. Modified Example 2

In the preceding embodiment, it is possible to selectively connect one of the two types of device units 810, 820 to the relay unit 600, but the relay unit 600 may be configured so that it is possible to connect only one type of device unit (e.g. the first type printer 810). In this case as well, as long as printer data acceptable to the actually connected device unit can be created within the relay unit 600, it will be possible to achieve the advantage of not having to modify implementation of the MFP device control unit 700 depending on the type of device unit connected.

D3. Modified Example 3

In the preceding embodiment, some of the arrangements realized through hardware in the preceding embodiments may instead be replaced by software; conversely, some of the arrangements realized through software may be replaced by hardware.

What is claimed is:

1. A network relay device compliant with network plug-and-play, for relay between a network and a device unit having one or more service devices that provide a service in response to a request from a client on the network, the network relay device comprising:
a data conversion module that, upon receiving from a client a print request message describing in markup language an image for printing, converts the print request message to data for use by the device unit and supplies the converted data to the device unit,
wherein the data conversion module creates, as the data for use by the device unit, printer data according to a universal standard acceptable by the device unit.

2. The network relay device according to claim 1, wherein
the device unit is capable of functioning as a printer, and
upon receiving a print request message from a client, the data conversion module creates printer data according to a universal standard to which the printer complies.

3. The network relay device according to claim 1, further comprising:
a USB host terminal for connecting a printer of a first type functioning as a USB device; and
a USB device terminal for connecting a printer of a second type functioning as a USB host,
wherein the data conversion module
(i) determines whether a printer of the first type or of the second type has been connected to the network relay device, depending on whether a printer has been connected to the USB host terminal or the USB device terminal;
(ii) when a printer of the first type has been connected to the network relay device, creates printer data according to a first universal standard, while when a printer of the second type has been connected to the network relay device, creates printer data according to a second universal standard different from the first universal standard.

4. The network relay device according to claim 3, wherein
the printer data according to the first universal standard includes RGB data, and
the printer data according to the second universal standard includes JPEG data.

5. The network relay device according to claim 4, wherein
in the event that a printer of the second type has been connected to the network relay device, the network relay device functions as a USB-compliant still image capture device.

6. The network relay device according to claim 1, comprising:
a device controller that includes the data conversion module and that operates the device unit by exchanging information with the device unit; and
a network protocol controller, connected between the network and the device controller, for receiving from a client on the network a message having a message header and a message body, and for transferring content of the message body to the device controller,
wherein the network protocol controller interprets the message header in accordance with the network plug-and-play protocols, without interpreting the content of the message body received from the client, and sends the message body to the device controller in accordance with a communications protocol different from the network plug-and-play protocols, and
the device controller interprets the content of the message body received from the network protocol controller, and causes the service device to execute a service according to a result of the interpretation.

7. A method for relay, using a network relay device in accordance with the network plug-and-play protocols, between a network and a device unit having one or more service devices that provide a service in response to a request from a client on the network, the method comprising the steps of
(a) receiving from the client a print request message describing in markup language an image for printing;
(b) converting the print request message to data for use by the device unit; and
(c) supplying the data for use by the device unit to the device unit,
wherein the step (b) includes creating printer data according to a universal standard acceptable by the device unit.

8. The method according to claim 7, wherein
the device unit is capable of functioning as a printer, and
the printer data is created according to a universal standard to which the printer complies.

9. The method according to claim 7, wherein the network relay device comprises:
a USB host terminal for connecting a printer of a first type functioning as a USB device; and
a USB device terminal for connecting a printer of a second type functioning as a USB host,
wherein the step (b) includes,
(i) determines whether a printer of the first type or of the second type has been connected to the network relay device, depending on whether a printer has been connected to the USB host terminal or the USB device terminal;
(ii) when a printer of the first type has been connected to the network relay device, creates printer data according to a first universal standard, while when a printer of the second type has been connected to the network relay device, creates printer data according to a second universal standard different from the first universal standard.

10. The method according to claim 9, wherein
the printer data according to the first universal standard includes RGB data, and
the printer data according to the second universal standard includes JPEG data.

11. The method according to claim 10, wherein
in the event that a printer of the second type has been connected to the network relay device, the network relay device functions as a USB-compliant still image capture device.
